(19) United States
(12) Patent Application Publication
(10) Pub. No.: US 2013/0083809 A1
(43) Pub. Date: Apr. 4, 2013

(54) COMMUNICATIONS SYSTEM FOR TRANSMISSION OF SIGNALS BETWEEN TERMINAL EQUIPMENT CONNECTED TO INTERMEDIATE EQUIPMENT CONNECTED TO AN ETHERNET NETWORK

(71) Applicants: Michel Renaux, Gennevilliers Cedex (FR); Michel Oustric, Gennevilliers Cedex (FR)

(72) Inventors: Michel Renaux, Gennevilliers Cedex (FR); Michel Oustric, Gennevilliers Cedex (FR)

(73) Assignee: THALES, Neuilly Sur Seine (FR)

(21) Appl. No.: 13/601,875

(22) Filed: Aug. 31, 2012

(30) Foreign Application Priority Data
Sep. 2, 2011 (FR) 1102674

(51) Int. Cl. H04J 3/06

(52) U.S. Cl. CPC H04J 3/0673
USPC 370/503

(57) ABSTRACT

A communication system for transmission of signals between various terminal equipment connected to various intermediate equipment and connected to a communications network using the Ethernet protocol is disclosed. In one aspect, the terminal equipment is not master-controlled by a distributed clock and the intermediate equipment each includes at least one Ethernet access physical interface. In the communication system, reference time information is periodically transmitted by the reference clock generator and distributed as data transport packets to the intermediate equipment via the Ethernet access physical interface. Each intermediate equipment includes a local clock generator, the reference time information is received and processed by each intermediate equipment, so as to subordinate the local clock generator to the reference clock. The mechanism configured to process the signals is clocked by the local clock generator so as to obtain synchronous processing of the transmitted signals.

### BACKGROUND

1. Field of the Invention

The present invention relates to a communications system allowing transmission of signals, notably signals conveying continuous data flows, between pieces of terminal equipment connected to intermediate pieces of equipment connected to a communications network using the Ethernet protocol, and a device of the associated intermediate equipment type.

More particularly, the invention is located in the field of transmission of signals requiring synchronous transmission, such as for example signals from synchronous serial links or analog connections with strong integrity constraint, on local networks LAN (local area network) or MAN (Metropolitan Area Network) notably.

2. Description of the Related Technology

In recent years, local networks of the Ethernet type, with asynchronous packet switching, have superseded other types of network architecture based on synchronous technologies such as time-multiplexing [symbol] Time Division Multiplexing [symbol] .

Nevertheless, for certain applications, such as for example digital audio or data remote transfer applications in the military field, the links between various pieces of equipment have to be synchronous. Further, it may be necessary to ensure common synchronization between more than two accesses, as well as a dynamic modification of the matrixing of certain connections without perturbing the other connections.

Therefore, there exists a need for synchronous data transmission even over a medium of the local network type with packet switching of the Ethernet type. Some Solutions for meeting this need have been proposed.

On the one hand, so-called adaptive methods are known, in which each piece of equipment connected to the network maintains buffer memories which are filled with the received data flow and are emptied at the rate for processing these data. Resynchronization of the data is accomplished from data stored in buffer memories reset at the beginning of the process to a filling threshold. This type of solution notably has the drawback of it being difficult to dimension the buffer memories in order to avoid loss of data in the case of overloading or shortage. Further, data processing from buffer memories generates delays. This solution is complicated, in particular for networks applying multipoint links, and which are therefore not limited to point-to-point links.

On the other hand, a synchronization technology for Ethernet known as SyncE has also been proposed. The SyncE solution uses a clock signal which is directly encoded on the communication line. Moreover, an Ethernet network conventionally comprises switches which allow terminal or intermediate equipment to be connected with each other, via point-to-point links (unicast) or point-to-multipoint links (broadcast or multicast). Therefore, specific switches are absolutely necessary for ensuring propagation of clock information.

Finally, in the field of computer networks, the [symbol] Network Time Protocol [symbol] (NTP) is known which allows synchronization of the clocks of different computers connected to a network on a reference clock. The NTP messages are transmitted at the application layer of the OSI (Open Systems Interconnection), and are processed at a software level. The transport and processing latency is not suitable for systems which require synchronization having a jitter of less than 50 nanoseconds (ns).

### SUMMARY OF CERTAIN ASPECTS OF THE INVENTION

Aspects of the invention relate to a communications system allowing transmission of signals between pieces of terminal equipment connected to intermediate pieces of equipment connected to a communications network using the Ethernet protocol, the pieces of terminal equipment not being subordinate by a distributed clock, the pieces of intermediate equipment each including at least one Ethernet access physical interface, at least one interface with a piece of terminal equipment and used for processing the transmitted signals, the communications system including at least one reference clock generator.

In one aspect, the communications system may include:
a piece of reference time information is periodically transmitted by the reference clock generator and distributed as data transport packets to the pieces of intermediate equipment via the physical interface for accessing Ethernet,
each piece of intermediate equipment includes a local clock generator, the piece of reference time information being received and processed for each piece of intermediate equipment, so as to subordinate the local clock generator to the reference clock, the mechanism for processing the signals being clocked by the local clock generator for thereby obtaining synchronous processing of the transmitted signals.

Advantageously, a piece of reference time information from the reference clock generator is conveyed in the form of data transport packets through the network, and each piece of intermediate equipment is synchronized by mechanism of this piece of reference time information which is emitted periodically. With this solution, it is possible to synchronize all the intermediate equipment on a same reference, regardless of the type of link, whether point-to-point or point-to-multipoint or multipoint-to-point or multipoint-multipoint. Acquiring synchronization does not require any user data flow, therefore: the connections are established in a network which is already synchronized and therefore more rapidly; modification of the matrixing of connections has no impact on the synchronization and therefore on the other connections.

By master-controlling the local clock generator it is then possible to synchronize all the processing mechanism, without requiring storage of data in buffer memories. The proposed system allows the use of clock generators, including the reference clock generator, which are on-shelf, or COTS (commercial off-the-shelf) products, and therefore has an economic asset.

In other aspects, the communications system may also have one or more of the features below:
the processing of the piece of reference time information comprises calculation of the difference between the local clock and the reference clock, and modification of the local clock if necessary depending on the calculated difference;
the mechanism for processing the signals from an intermediate piece of equipment include mechanism for digitizing user signals provided by a piece of terminal equipment, allowing the characterization of the user signals in order to regenerate them with the same frequency and amplitude characteristics by the digitization mechanism of another piece of intermediate equipment;
the data processing mechanism of a piece of intermediate equipment include:
   digital mechanism for formatting user data from the digitization of user signals, in sequenced digital data transport packets and capable of being transmitted over the Ethernet network, and
   mechanism for de-formatting digital data transport packets, into digital user data capable of being provided for generating user signals intended for a piece of terminal equipment;
the piece of reference time information is formatted and distributed according to the [symbol] Precision Time Protocol [symbol] defined by the IEEE 1588-V2 standard;
the piece of reference time information comprises a piece of reference clock frequency information and a date reference;
the communications system further comprising switches capable of transferring digital data transport packets in an asynchronous mode, between various pieces of equipment of the communications network, the piece of reference time information is conveyed in a data transport packet which is transferred without any particular processing by a the switch.

According to another aspect, the invention relates to a device of the intermediate equipment type connected to a communications network using the Ethernet protocol, via at least one Ethernet access physical interface, including at least one interface capable of exchanging signals with at least one piece of terminal equipment, and mechanism for processing signals exchanged with the at least one piece of terminal equipment and transmitted via the communications network. The device includes a local clock generator capable of processing a piece of reference time information received as data transport packets via a so-called Ethernet access physical interface, so as to subordinate the local clock generator to a reference clock, the local clock generator being capable of clocking the signal processing mechanism so as to obtain synchronous processing of the transmitted signals.

Other aspects of the device may also have one or more of the features below:
the local clock generator comprises mechanism for calculating the difference between the local clock and the reference clock, and mechanism for modifying the local clock if necessary depending on the calculated difference;
the mechanism for processing the signals include mechanism for digitizing user signals provided by a final piece of equipment allowing the characterization of the user signals in order to regenerate them with the same frequency and amplitude characteristics by digitization mechanism of another piece of intermediate equipment.

### BRIEF DESCRIPTION OF THE DRAWINGS

Other features and advantages of the invention will become apparent from the description which is given below, as an indication and by no mechanism as a limitation, with reference to the appended figures.

FIG. 1 illustrates a set of pieces of equipment connected via an Ethernet network;

FIG. 2 illustrates a communications system applying the invention, and

FIG. 3 is a block diagram of a device of the intermediate equipment type adapted to implement the invention.

### DETAILED DESCRIPTION OF CERTAIN INVENTIVE EMBODIMENTS

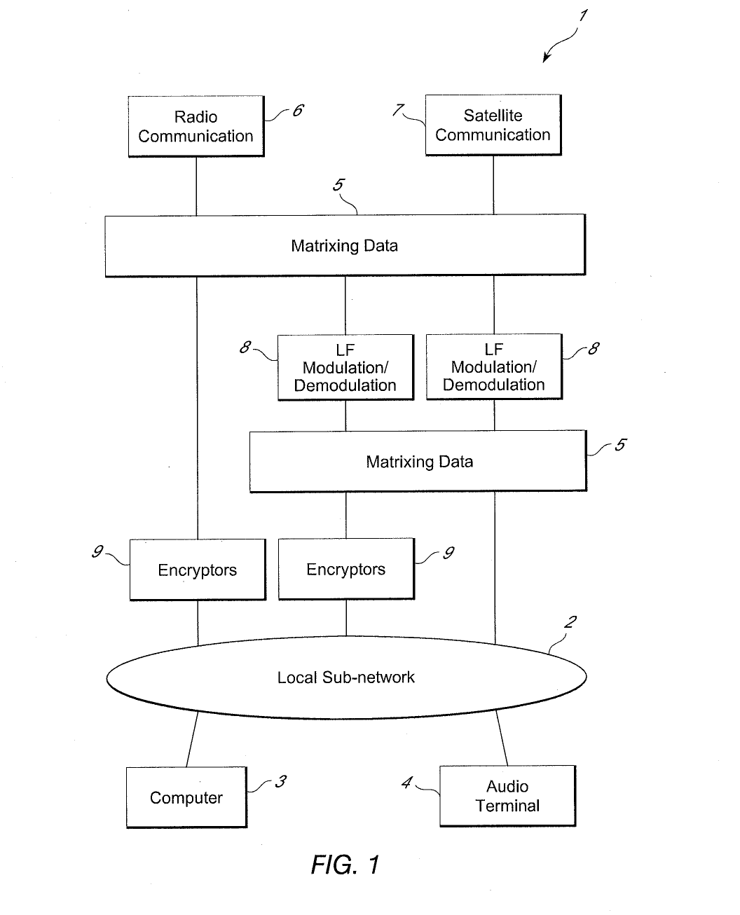

FIG. 1 illustrates an exemplary communications system 1 in which the invention finds an application. The communications system 1 comprises a local sub-network 2 to which are connected pieces of terminal equipment such as a computer 3 or an audio terminal 4, which provide serial data of the V24 type or analog signals.

These signals are transmitted via matrixing mechanism 5 to external communication mechanism, for example radio-communication mechanism 6 and satellite communication mechanism 7. The matrixing mechanism 5 carry out matrixing and certain processing operations on the user data.

Additional LF modulation/demodulation mechanism 8 are inserted in order to ensure conversion of the user data to be transmitted into the suitable format supported by the transmission mechanism and vice versa, mechanism for converting the data received from the outside world into a user data format.

Further, in order to ensure confidentiality of the data, encryptors 9 are added into the system.

Signals conveying user data, either encrypted or not, are transmitted in the communications system 1. The transmission of these signals should guarantee integrity, including over a long period, of the conveyed data. For this purpose, the matrixing mechanism implement a synchronous gate function as explained in more detail hereafter, thereby ensuring synchronous transmission of signals conveying digital user data over an Ethernet network.

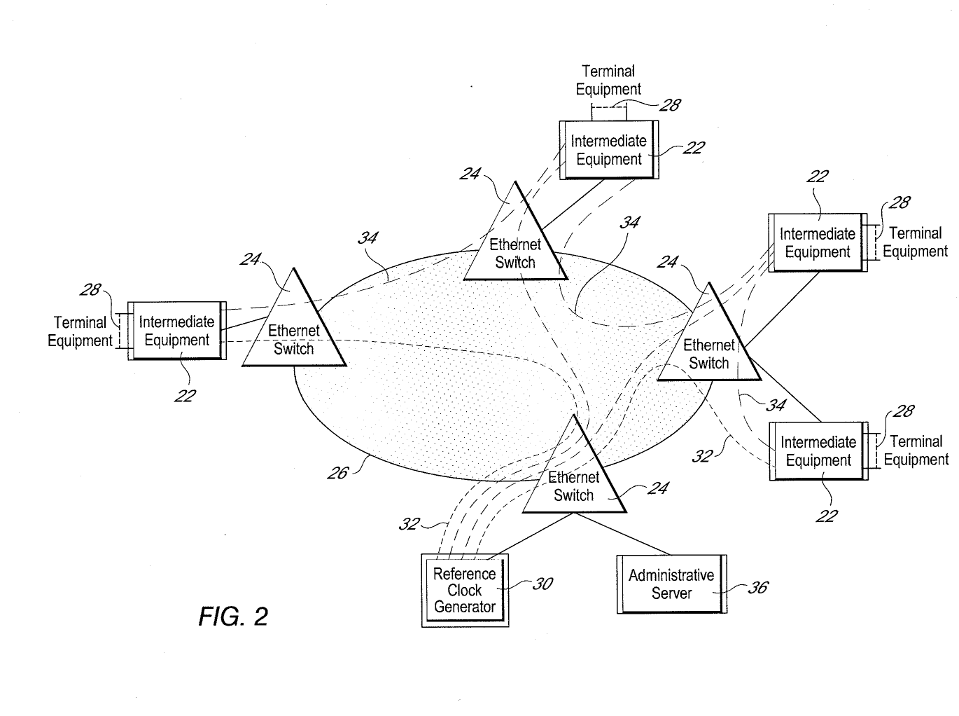

FIG. 2 illustrates a global architecture of a communications system 20 according to the invention comprising a plurality of pieces of intermediate equipment 22 ensuring a synchronous gate function, connected to Ethernet switches 24 connected to the Ethernet network 26, via an Ethernet access physical interface, not shown in this figure. Further, each piece of intermediate equipment 22 is connected to one or more pieces of terminal equipment 28 providing signals conveying user data. The terminal equipment for example provides various types of user access: audio access (LF signals and discrete signals), serial link of the V24, ISDN (Integrated Services Device Network) type. The pieces of terminal equipment are not master-controlled by a distributed clock.

A piece of intermediate equipment in the sense of the invention comprises mechanism for generating a local clock on the one hand and mechanism for processing the transmitted signals, either implemented in a same hardware block, or in several hardware blocks connected together, on the other hand.

The communications system comprises a reference clock generator 30, which periodically generates a piece of reference time information which is transmitted to the various pieces of intermediate equipment 22 via a data flow 32, which conveys this piece of reference time information encapsulated in transport packets at the network level or at the link level of the OSI model, in the same way as the other data, for example the user data, transmitted over the network.

In an embodiment, the reference clock is synchronized on a global clock for example via the GPS system.

The digital user data are conveyed in flows 34, also in the form of transport packets at the network level.

The number of pieces of intermediate pieces of equipment 22 is variable depending on the number of pieces of terminal equipment 28 to be connected, on the number of [symbol] user [symbol] ports available on a piece of intermediate equipment 22, as well as on the geographic distribution of the terminal equipment. The number of pieces of terminal equipment 28 connected to a piece of intermediate equipment 22 is variable from one piece of intermediate equipment to the other depending on the application needs.

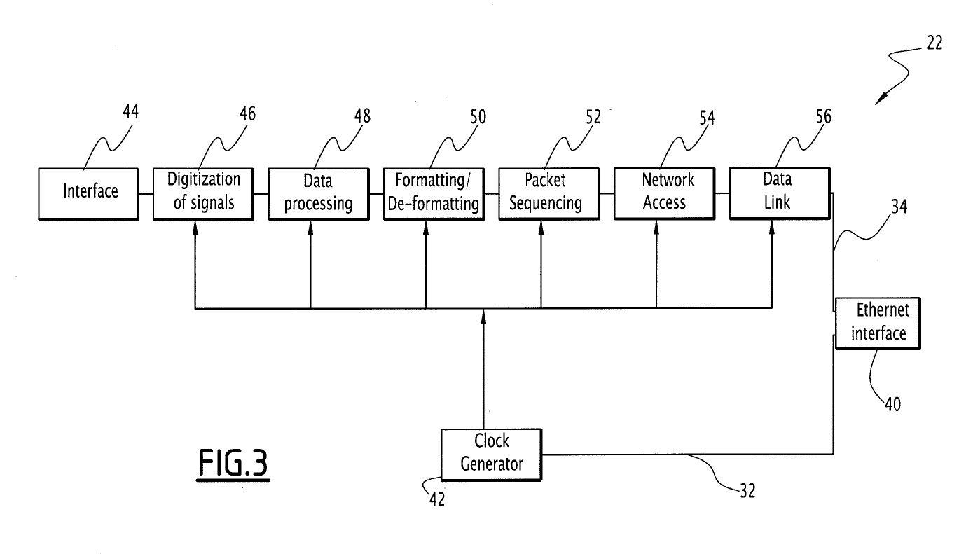

The communications system also optionally includes an administration server 36 which has the role of calculating and then distributing to the intermediate equipment 22, information identifying the ends of the interconnections to be carried out or to be suppressed on the one hand, the parameters of configurations of signal processing functions, as described in more detail hereafter with reference to FIG. 3, on the other hand.

In the preferred embodiment, the piece of reference time information is formatted and broadcast according to the [symbol] Precision Time Protocol [symbol] (PTP) defined by the IEEE 1588-V2 standard. Typically, the piece of reference time information comprises a piece of information on the frequency of the reference clock and a date reference.

The piece of reference time information is a message of the [symbol] time stamp [symbol] type according to PTP which is periodically transmitted, with a transmission period ranging up to 128 messages per second, which allows a residual jitter between the reference clock and the local clock of a few tens of nanoseconds. More generally, the periods for transmitting 2ⁿ messages/second, with n varying from 1 to 8, are contemplated in PTP.

The operation for broadcasting messages of the [symbol] time stamp [symbol] type for synchronization in a differential mode according to the PTP protocol is the following: a SYNC message comprising a date-time reference (t1) for the time upon sending the reference clock, is sent according to the [symbol] unicast [symbol] or [symbol] multicast [symbol] mode, over the network and received by the local clock generator of a piece of equipment 22 for which the local clock has to be subordinated to the reference clock. The receiving instant t2 is recorded by the equipment 22. Optionally, a message of the FOLLOW UP type is sent back by the reference clock containing the specific instant t1 when the preceding message was sent. This allows the piece of equipment 22 to calculate a delay dm2s=t2−t1. This transmission delay between the reference clock generator 30 and the piece of equipment 22 comprises the transmission time over the network and the time shift or offset between both clocks.

The piece of equipment 22 then sends a request for a delay DELAY_REQ at an instant t3, and this instant is recorded as t3. The reference clock generator receives this message DELAY_REQ at an instant t4 and sends the value of t4 in a reply message DELAY_RESP which is received by the piece of equipment 22 which may thereby calculate the delay ds2m=t4−t3.

The time shift between the clocks or offset is then calculated by: off=(dm2s−ds2m)/2, while supposing the transmission time of the messages is symmetrical between the pieces of equipment.

The local clock then applies the calculated off difference for correcting its possible time shift relatively to the reference clock, and thus becomes subordinate to the reference clock.

Advantageously, the broadcasting of messages of the PTP [symbol] time stamp [symbol] is accomplished at the link level or the network level and the messages are directly processed by the hardware, therefore at the physical layer level, therefore the transmission and processing are carried out very rapidly, thereby guaranteeing a jitter of the local clock of less than 50 nanoseconds (ns). By this system of synchronization of local clocks, all the intermediate equipment 22 apply the master-control of their local clock, which gives the possibility of having complete synchronization in the communications system 20. Thus, the digital user data flows 34 are transmitted, according to the [symbol] unicast [symbol] mode, intended for a piece of intermediate equipment or duplicated and then transmitted, according to the [symbol] unicast [symbol] mode, to several pieces of intermediate equipment, thereby achieving a point-multipoint transmission.

The Ethernet switches 24 do not need to implement the PTP protocol, insofar that the data flow 32 conveying the piece of reference time information has the same format as another flow of digital user data 34. In this case, the processing is particularly simple at the Ethernet switches 24.

In an alternative, the Ethernet switches 24 also implement the PTP protocol and correct the delay which they introduced. Each Ethernet switch 24 calculates its time for letting through the [symbol] time stamp [symbol] messages and adds to the retransmitted messages this delay in a specific field. This information is then used by the intermediate equipment 22 for correcting their offset calculation of the variable time for crossing the Ethernet switches 24.

Alternatively, the communications system 20 includes several pieces of equipment behaving like a reference clock generator. In this case, a quality score is assigned to each generator. The system utilizes the available clock which provides the best quality. Moreover, the function(s) of reference clock generators is(are) integrated to the intermediate equipment which may, depending on the configuration, be a transmitter or receiver of the reference clock.

FIG. 3 illustrates an exemplary piece of intermediate equipment 22 or synchronous gate according to the invention.

Such an piece of intermediate equipment 22 includes an Ethernet access physical interface 40 which transmits the reference time information flow 32 to a local clock generator 42, and exchanges the digital user data 34 flow with the other modules which implement mechanism for processing the data from the piece of intermediate equipment 22. Differentiation between the time information flow and the digital user data flow is accomplished at the headers of the packets. According to the choice of implementation, this differentiation is either at the MAC (Medium Access Control) address level or at the IP (Internet Protocol) address level, or at the UDP (User Datagram Protocol) port level.

As explained earlier with reference to FIG. 2, the local clock generator 42 processes the piece of reference time information for correcting its difference relatively to the reference clock, and transmits this local clock to all the other processing mechanism, so as to clock their processing operations at the hardware level and to make them synchronous in frequency relatively to the reference clock generator, which ensures synchronous processing of the signals conveying the user data.

For the processing of signals conveying user data, the equipment 22 includes at least one interface 44 for matching the electric constraints of these user signals.

The piece of equipment 22 further includes digitization mechanism 46 ensuring the characterization of the user signals, adapted to the nature of the latter, in order to regenerate them with the same frequency and amplitude characteristics on the piece of intermediate equipment of the other end(s). In the case of analog signals, the digitization mechanism 46 ensure analog/digital and digital/analog conversion for converting the user signals conveying analog user data into digital user data, and vice versa. In the case of synchronous data, for example for a serial link of the V24 type, the digitization mechanism 46 ensure sampling of the data and measurement of the phase and frequency of the clock signals, or conversely the regeneration of the frequency of the clock signals.

The piece of equipment 22 also includes mechanism 48 for processing digital user data, allowing the interconnection of pieces of terminal equipment not having the same signals on their interface, for example emulation of signals, multiplexing of signals, or mixing of data in the case of user access requiring the processing of data from several pieces of intermediate equipment contributing to multipoint-point or multipoint-multipoint transmission.

Further, the piece of equipment 22 includes formatting/de-formatting mechanism 50, which ensure the formatting of digital user data into sequenced digital data transport packets and capable of being transmitted over the Ethernet network. For example, the data of a same user port are multiplexed in a datagram with the RTP format. The formatting/de-formatting mechanism optionally also ensure a supervision function, with which it may be ascertained that the process flows upon reception are actually those of the requested connection. For this purpose, at the formatting level, a piece of information identifying the receiving piece of equipment is inserted into the digital data packets. Such an identifier is unique in the system at a given instant, and is for example provided by the administration server 36. At the de-formatting level, the identifier is checked and the data are only processed in the case of a positive check. In the opposite case, the data are deleted. This function allows an increase in the safety of the transmission of user signals.

Further, the piece of equipment 22 includes mechanism 52 for sequencing the data transport packets and network access mechanism 54 which ensure the implementation of the network layer.

The piece of equipment 22 also includes data link mechanism 56 which ensure the implementation of the corresponding protocol layer or MAC layer. The linking mechanism 56 process the received digital user data flows 34 and those to be sent back via the Ethernet physical access module 40.

In a first embodiment, the piece of intermediate equipment 22 is a device including in an integrated way, the clock generator 42 on the whole of the processing modules 44 to 56.

In an alternative embodiment, the piece of intermediate equipment 22 consists of several interconnected hardware blocks, one block implementing the clock generator 42 on the one hand and one or several blocks implementing the processing modules 44 to 56 on the other hand.

All the processing mechanism 46 to 56 are clocked by the local clock generator 42, which applies the correction in a differential mode so as to be frequency-subordinated to the reference clock generator.

For example, when the user data are audio signals, the digitization mechanism 46 are driven synchronously with the reference clock.

Thus, the communications system allows synchronous transmission of signals conveying user data between terminal equipment not master-controlled by a distributed clock, via intermediate equipment connected to an Ethernet network.

While there have been shown and described and pointed out the fundamental novel features of the invention as applied to certain inventive embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplate. All such modifications and variations are within the scope of the invention as determined by the appended claims when interpreted in accordance with the breadth to which they are entitled.

What is claimed is:

1. A communications system allowing the transmission of signals between pieces of terminal equipment connected to pieces of intermediate equipment, connected to a communications network using the Ethernet protocol, the pieces of terminal equipment not being master-controlled by a distributed clock, the pieces of intermediate equipment each including at least one Ethernet access physical interface, at least one interface with a piece of terminal equipment and a mechanism configured to process the transmitted signals, the communications system including at least one reference clock generator, wherein
reference time information is periodically transmitted by the reference clock generator and distributed as data transport packets to the pieces of intermediate equipment via the Ethernet access physical interface,
each piece of intermediate equipment includes a local clock generator and the reference time information being received and processed by each piece of intermediate equipment, so as to subordinate the local clock generator to the reference clock, and
the processing mechanism being clocked by the local clock generator so as to realize synchronous processing of the transmitted signals.

2. The communications system according to claim 1, wherein the processing of the reference time information comprises a calculation of the difference between the local clock and the reference clock, and a modification of the local clock if necessary depending on the calculated difference.

3. The communications system according to claim 1, wherein the processing mechanism comprises:
a mechanism configured to digitize user signals provided by a piece of terminal equipment, allowing characterization of the user signals in order to regenerate them with the same frequency and amplitude characteristics by the digitization mechanism of another piece of intermediate equipment.

4. The communications system according to claim 1, wherein the processing mechanism comprises:
a mechanism configured to format digital user data from the digitization of the user signals into sequenced digital data transport packets and capable of being transmitted over the Ethernet network, and
a mechanism configured to de-format the digital data transport packets into digital user data capable of being provided for generating the user signals intended for a piece of terminal equipment.

5. The communications system according to claim 1, wherein the reference time information is formatted and distributed according to the [symbol] Precision Time Protocol [symbol] defined by the IEEE 1588-V2 standard.

6. The communications system according to claim 5, wherein the piece of reference time information comprises frequency information of the reference clock and a date reference.

7. The communications system according to claim 1, further comprising a plurality of switches configured to transfer digital data transport packets in an asynchronous mode, between various pieces of equipment of the communications network, wherein the reference time information is conveyed in a data transport packet transferred without any particular processing by any one of the switches.

8. A device of the intermediate equipment type connected to a communications network using the Ethernet protocol, via at least one Ethernet access physical interface including at least one interface capable of exchanging signals with at least one piece of terminal equipment and a mechanism configured to process signals exchanged with the at least one piece of terminal equipment and transmitted via the communications network, wherein
a local clock generator is configured to process reference time information received as data transport packets via a so-called Ethernet access physical interface, so as to subordinate the local clock generator to a reference clock, and
the local clock generator is also configured to clock the processing mechanism so as to obtain synchronous processing of the transmitted signals.

9. The device of the intermediate equipment type according to claim 8, wherein the local clock generator comprises a mechanism configured to calculate the difference between the local clock and the reference clock and mechanism for modifying the local clock, if necessary, depending on the calculated difference.

10. The device of the intermediate equipment type according to claim 8, wherein the processing mechanism comprises:
a mechanism configured to digitize user signals provided by a final piece of equipment allowing characterization of the user signals in order to regenerate them with the same frequency and amplitude characteristics by a digitization mechanism of another piece of intermediate equipment.
